(19) United States
(12) Patent Application Publication
(10) Pub. No.: US 2007/0006755 A1
(43) Pub. Date: Jan. 11, 2007

(54) ADJUSTING DEVICE FOR POSITIONING A LOAD

(76) Inventor: JUERGEN ZIMMERMANN, Bregenz (AT)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/427,869

(22) Filed: Jun. 30, 2006

(30) Foreign Application Priority Data
Jul. 5, 2005 (AT) GM 454/2005

(51) Int. Cl. B41F 13/24

(52) U.S. Cl. 101/248

(57) ABSTRACT

An adjusting device for positioning a load comprises a threaded spindle, which is connected in the region of a longitudinal end to a carrier toothed wheel so as to be fixed with respect to rotation relative to it and so as to be fixed with respect to displacement axially, and a spindle nut which is arranged on the spindle thread and which is displaceable axially by means of a rotation of the threaded spindle for positioning the load. A fastening portion of the threaded spindle which is formed in the region of the longitudinal end of the threaded spindle has, in addition to a cylindrical portion which is received by a cylindrical portion of the through-opening of the carrier toothed wheel and in which torque is transmitted between the carrier toothed wheel and the fastening portion by a key, another conical portion which is situated closer to the longitudinal center of the threaded spindle and which widens in direction of the longitudinal center of the threaded spindle and which is received by a conical portion of the through-opening of the carrier toothed wheel, wherein the conical portion of the fastening portion and the conical portion of the carrier toothed wheel are clamped against one another by a clamping nut.

### CROSS-REFERENCE TO RELATED APPLICATION

This application claims priority of Austrian Application No. GM 454/2005, filed Jul. 5, 2005, the complete disclosure of which is hereby incorporated by reference.

### BACKGROUND OF THE INVENTION

a) Field of the Invention

The invention is directed to an adjusting device for positioning a load. The adjusting device comprises a threaded spindle which is connected in the region of a longitudinal end to a carrier toothed wheel, particularly in the form of a worm gear, so as to be fixed with respect to rotation relative to it and so as to be fixed with respect to displacement axially, which carrier toothed wheel is rotatably mounted in a gear unit housing and can be set in rotation by means of a driving toothed wheel, particularly in the form of a worm, whose teeth engage in the teeth of the carrier toothed wheel. The adjusting device further comprises a spindle nut which is arranged on the spindle thread and which is displaceable axially by means of a rotation of the threaded spindle for positioning the load. A fastening portion of the threaded spindle which is formed in the region of the longitudinal end of the threaded spindle and along which the spindle thread is at least partially turned penetrates a central opening through the carrier toothed wheel and is connected to the carrier toothed wheel by a key and, further, is provided with a screw thread in an end portion projecting out of the through-opening of the carrier toothed wheel, a clamping nut which clamps the threaded spindle against the carrier toothed wheel being screwed onto this screw thread.

b) Description of the Related Art

Adjusting devices of the type mentioned above are known and are also called spindle lifting gear units, spindle nut gear units, or actuating drive units. Adjusting devices of this type are used for positioning loads in the form of structural component parts or component groups. For example, these adjusting devices are used in lifting platforms, lifting jacks, vertically adjustable platforms, valves with valve slides that are adjustable by motor, forms for concrete that are adjustable by motor, and so on.

In adjusting devices of this kind, rotational movements (of the drive motors or crank mechanisms) are transformed into linear movements either of the threaded spindle or of a spindle nut arranged on the thread of the threaded spindle. In the first instance, in contrast to the generic type, a carrying nut is rotatably mounted in a gear unit housing, and the threaded spindle, which is not rotatable, is displaced in axial direction by rotating the carrying nut. In the second instance, the threaded spindle is connected to a carrier toothed wheel, usually in the form of a worm gear, so as to be fixed with respect to rotation relative to it, this carrier toothed wheel being rotatably mounted in the gear unit housing. When the carrier toothed wheel, and therefore the threaded spindle, is rotated a spindle nut which is arranged on the thread of the threaded spindle and fixed with respect to rotation is displaced in axial direction of the threaded spindle.

As regards spindle nut gear units in which the threaded spindle is rotatable and is connected to the carrier toothed wheel, usually a worm gear, so as to be fixed with respect to rotation relative to it, there are various known constructions for connecting the threaded spindle to the carrier toothed wheel.

In a first conventional embodiment form, a threaded rod with a continuous thread (in the form of a trapezoid thread) which is turned along an end portion to form a cylindrical shaft is used as the starting product for the threaded spindle. A spacer sleeve is first slipped onto this end portion and contacts the step between the cylindrical shaft and the beginning of the thread. The carrier toothed wheel is then slipped onto the cylindrical shaft and contacts the spacer sleeve at one side. In the region of the free end of the shaft, this shaft is provided with a fine-pitch thread (i.e., a screw thread) on which the clamping nut is screwed. This clamping nut clamps the carrier toothed wheel and the spacer sleeve against the step between the shaft and the spindle thread of the spindle. Further, in order to prevent rotation, a key is inserted into the cylindrical shaft and engages in a corresponding recess in the carrier toothed wheel. While this connection between the spindle and the worm gear can be produced relatively simply and, further, a threaded rod which can be commercially obtained inexpensively as a piece good can be used as a starting product for the threaded spindle, the problem arises that the step between the spindle thread and the cylindrical shaft does not present a uniform contact surface for the spacer sleeve because of the turned, helically extending thread. The clamping of the carrier toothed wheel and the spacer sleeve against this shoulder can lead to axial bending between the longitudinal axis of the cylindrical shaft and the threaded portion of the threaded spindle resulting in unwanted eccentricity. However, it is not practicable to enlarge this step while reducing the diameter of the shaft at a given diameter of the threaded spindle because of the torques and possible tensile forces to be absorbed by the cylindrical shaft. Axial bearings are arranged on shoulders provided at both sides of the carrier toothed wheel for rotatable bearing support of the threaded spindle relative to a housing.

Therefore, in another conventional adjusting device with a rotatable threaded spindle, a cylindrical shaft is used as starting material for the threaded spindle, a trapezoid thread being turned on this cylindrical shaft, specifically, substantially along the entire length of the threaded spindle with the exception of a fastening portion at one end of the shaft. This fastening portion at the end has a cylindrical portion adjoining the trapezoid thread of the threaded spindle, the outer diameter of the cylindrical portion lying between the inner radius and the outer radius of the trapezoid thread. Adjoining this cylindrical portion by a step is a cylindrical portion having a smaller diameter which carries the carrier toothed wheel (also constructed as a worm gear in this instance) that contacts the step between the two cylindrical portions. A key is again provided for preventing rotation between the carrier toothed wheel and the cylindrical portion having the smaller diameter. In the area of the end of the threaded spindle, a fine-pitch thread (screw thread) is cut into the cylindrical portion having the smaller diameter. A clamping nut which clamps the carrier toothed wheel against the shoulder is screwed onto this fine-pitch thread. Axial ball bearings mounted on shoulders of the worm gear are again provided for rotatable support of the threaded spindle. Further, a radial ball bearing is arranged between the housing and the cylindrical portion with the larger diameter. This construction is very costly to produce, particularly due to that fact that a pre-manufactured threaded rod cannot be used to produce the threaded spindle, and the threaded spindle must be manufactured from a cylindrical shaft, wherein the thread of the threaded spindles must be produced.

In another embodiment form for connecting the threaded spindle to the carrier toothed wheel, the carrier toothed wheel has an internal thread by means of which it is screwed on the thread of the threaded spindle. In this case, special clampable lock nuts must be provided for securing the carrier toothed wheel to the threaded spindle and, further, the carrier toothed wheel must be provided with tolerance-compensating bushings to reduce the clearance between the threaded spindle and the carrier toothed wheel. While pre-manufactured threaded rods can be used for the threaded spindles because of these steps, the construction is very costly overall and the torque in its entirety must be transmitted via the clamped lock nuts.

### OBJECT AND SUMMARY OF THE INVENTION

It is the primary object of the invention to provide an adjusting device of the kind mentioned above with a connection between the threaded spindle and the carrier toothed wheel which is simple to produce and in which the occurring torques and forces are reliably transmitted, while ensuring the best possible parallel and concentric orientation of the longitudinal axis of the threaded spindle relative to the axis of rotation of the carrier toothed wheel.

According to the invention, this object is met by an adjusting device for positioning a load, comprising a threaded spindle which is connected in the region of a longitudinal end to a carrier toothed wheel so as to be fixed with respect to rotation relative to it and so as to be fixed with respect to displacement axially, which carrier toothed wheel is rotatably mounted in a gear unit housing and can be set in rotation by means of a driving toothed wheel whose teeth engage in the teeth of the carrier toothed wheel, and a spindle nut which is arranged on a spindle thread of the threaded spindle and which is displaceable axially by means of a rotation of the threaded spindle for positioning the load, wherein a fastening portion of the threaded spindle which is formed in the region of the longitudinal end of the threaded spindle and along which the spindle thread is at least partially turned penetrates a central through-opening through the carrier toothed wheel and is connected to the carrier toothed wheel by a key and, further, is provided with a screw thread in an end portion which projects out of the through-opening of the carrier toothed wheel, a clamping nut which clamps the threaded spindle against the carrier toothed wheel being screwed onto this screw thread, and the fastening portion has, in addition to a cylindrical portion which is received by a cylindrical portion of the through-opening of the carrier toothed wheel and in which torque is transmitted between the carrier toothed wheel and the fastening portion by the key, another conical portion which is situated closer to the longitudinal center of the threaded spindle and which widens in direction of the longitudinal center of the threaded spindle and which is received by a conical portion of the through-opening of the carrier toothed wheel, wherein the conical portion of the fastening portion and the conical portion of the carrier toothed wheel are clamped against one another by the clamping nut.

The key which extends at least along most of its length in the area of the cylindrical portion of the fastening portion of the threaded spindle serves to transmit torque between the carrier toothed wheel and the threaded spindle. However, torque can also be transmitted by means of the cooperating conical portions of the threaded spindle and of the carrier toothed wheel, which allows a compact construction with respect to height in spite of the different portions of the fastening portion of the threaded spindle. The cooperating conical portions also ensure the parallel orientation of the longitudinal axis of the threaded spindle and of the axis of rotation of the carrier toothed wheel without having to undertake special steps in assembly. This results in a very simple assembly process

The threaded spindle of the adjusting device according to the invention can advantageously be produced from a standard rolled threaded rod which is obtainable as a stock item. The invention can be used not only for threaded spindles with trapezoid threads but also for threaded spindles with ball threads.

Bevel seat connections in which the connection is carried out by means of the cooperation of conical connection parts are known per se. In particular, bevel seat connections of this kind are used to connect clamping chucks of drills to the drill shaft. It is also known to connect hubs to shafts by means of clamping cones. These commonly known bevel seat connections do not relate to generic devices.

In an advantageous embodiment form of the invention, the fastening portion of the threaded spindle has a second cylindrical portion in addition to the first cylindrical portion in which the threaded spindle is connected to the carrier toothed wheel by the key. This second cylindrical portion lies closer to the longitudinal center of the threaded spindle than the conical portion and preferably directly adjoins the conical portion. This second cylindrical portion is received at least over a portion of its longitudinal extension by a second cylindrical portion of the through-opening of the carrier toothed wheel, wherein a sliding fit is preferably formed between the second cylindrical portions of the fastening portion and of the through-opening of the carrier toothed wheel, i.e., a fit with only very slight clearance. This leads to an additional radial support of the threaded spindle in the carrier toothed wheel. This further improves stability with respect to transverse forces. An optimal orientation of the longitudinal axis of the threaded spindle parallel to and concentric to the axis of rotation of the carrier toothed wheel is ensured in addition.

As was already mentioned, the different portions of the fastening portion of the threaded spindle can be produced in the area of a longitudinal end, preferably by a defined turning of the threaded rod from which the threaded spindle is formed. In the conical portion, the thread of the threaded rod can be completely turned or a more or less large portion of the thread can remain along a more or less large longitudinal portion of the cylindrical portion depending on the outer diameter and core diameter (inner diameter of the thread) of the threaded rod that is used. In the area in which a portion of the outer thread remains, the turned outer surface of the thread forms the conical outer surface of the conical portion.

Also, the thread of the threaded rod can be completely turned or only partially turned in the second cylindrical portion that is preferably provided. In the latter case, the cylindrically turned outer surface of the remaining portion of the thread forms the cylindrical outer surface of the cylindrical portion.

However, in the (first) cylindrical portion which is arranged between the conical portion and the screw thread, the thread of the threaded rod used as starting material is preferably completely turned. Accordingly, there is a continuous cylindrical outer surface in this case.

Other advantages and details of the invention are described in the following with reference to the accompanying drawings.

### BRIEF DESCRIPTION OF THE DRAWINGS

FIG. 1 shows a base unit comprising the gear unit housing and the toothed wheels which are rotatably supported therein in longitudinal section through the gear unit housing according to an advantageous embodiment form of the invention;

FIGS. 2a and 2b show the fastening portion and an adjoining portion of the main portion of a threaded spindle which can be connected to the base unit of FIG. 1 in two side views that are rotated by 90° (in a different scale than that shown in FIG. 1);

FIG. 3 shows the adjusting device according to this embodiment example of the invention in the assembled state (the base unit is again shown in cross section, and the threaded spindle is shown in a side view in the area of the gear unit housing and schematically in the area of a spindle nut arranged on it) with a load to be adjusted, shown schematically;

FIG. 4 shows a section along line AA of FIG. 3;

FIG. 5 and FIG. 6 show views of the base unit of FIG. 1 with threaded spindles which are inserted therein and which have different diameters than the threaded spindle shown in FIGS. 2 to 4; and

FIG. 7 shows the base unit with an inserted threaded spindle which has a ball thread.

Different scales are used in the drawings.

### DESCRIPTION OF THE PREFERRED EMBODIMENTS

FIG. 1 shows the base unit of the adjusting device according to an advantageous embodiment form of the invention. This base unit comprises the gear unit housing 1 and the toothed wheels 2, 7 which are rotatably mounted therein. The carrier toothed wheel 2 serves to hold the threaded spindle 3 which is described in the following. In the present embodiment example, the carrier toothed wheel 2 is constructed as a worm gear and accordingly has an external worm toothing. Construction in the form of a different type of toothed wheel, for example, a bevel gear wheel, is conceivable and possible.

The carrier toothed wheel 2 is mounted in the gear unit housing 1 so as to be rotatable by means of axial bearings 4, 5.

Further, the hub of the carrier toothed wheel 2 has an axial through-opening 6 serving to receive the threaded spindle 3. The construction of this through-opening 6 will be described following the description of the threaded spindle 3.

The carrier toothed wheel 2 can be rotated by means of the driving toothed wheel 7 which is rotatably mounted in the gear unit housing 1 and whose teeth engage with the teeth of the carrier toothed wheel 2. The driving toothed wheel 7 is constructed as a worm in the present embodiment example. Depending on the construction of the carrier toothed wheel 2, other constructions are also conceivable and possible, for example, construction in the form of a bevel gear wheel.

The driving toothed wheel 7 has a drive shaft, not shown in the drawing, which projects out of the gear unit housing 1 and by which it can be driven, particularly by means of a drive motor.

The gear unit housing 1 has a housing base part 8 with an inner receiving space 9 for the rotatably supported toothed wheels 2, 7 and a housing cover 10 which is screwed into the housing base part 8 and which has an opening 11 as a through-guide for the threaded spindle 3. The housing cover 10 has an annular flange 12 which surrounds the opening 11 and into which a bushing 13 is pressed. This bushing can be made of brass, for example.

On the opposite side of the housing cover 10, a cover 14 closes an opening of the housing base part 8. Further, the gear unit housing 1 has a lubricating bore hole 15 and swivel bearing bushes 17 which are pressed into recesses 16.

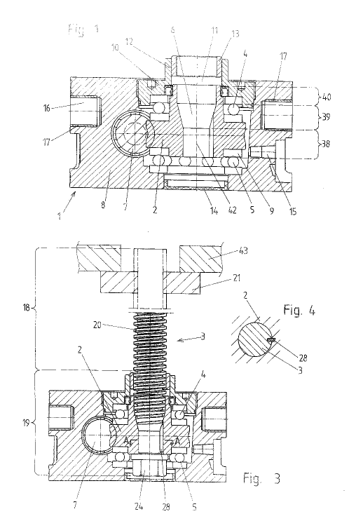

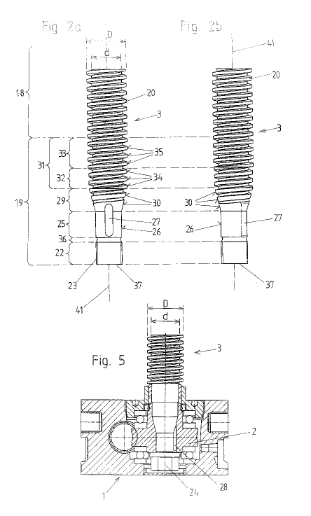

The threaded spindle 3 is constructed as a trapezoid thread spindle in the embodiment forms according to FIGS. 2 to 6. It comprises a main portion 18 along which the spindle thread 20 extends and with which the spindle nut 21 (see FIG. 3) engages. The spindle nut 21 can be axially adjusted in the main portion 18 of the threaded spindle 3. In the main portion 18, there is no machining of the thread of the threaded rod from which the threaded spindle 3 is preferably produced.

A fastening portion 19 comprising a plurality of portions 22, 25, 36, 29, 31 is formed in the area of a longitudinal end of the threaded spindle 3.

An end portion 22 which projects out of the through-opening 6 of the carrier toothed wheel 2 when the threaded spindle 3 is connected to the carrier toothed wheel 2 is provided with a screw thread (fine-pitch thread) 23 on which a clamping nut 24 (see FIG. 3) can be screwed. This end portion 22 preferably directly adjoins the longitudinal end 37 of the threaded spindle 3.

A first cylindrical portion 25 of the fastening portion 19 is located closer to the longitudinal center of the threaded spindle 3 (that is, farther away from the adjoining longitudinal end 37). This first cylindrical portion 25 preferably adjoins the end portion 22 provided with the screw thread 23 by way of an expansion portion 36. This first cylindrical portion 25 has a cylindrical outer surface 26 and is provided with a receiving groove 27 for a key 28 (see FIGS. 3 and 4). The receiving groove 27 extending in direction of the longitudinal axis 41 of the threaded spindle 3 is not visible in the side view according to FIG. 2b, but is indicated by a dashed line.

A conical portion 29 is located closer to the longitudinal center of the threaded spindle 3 than the first cylindrical portion 25. This conical portion 29 expands (i.e., increases in diameter) in direction of the longitudinal center of the threaded spindle 3 and has a conical outer surface 30. The conical portion 29 preferably directly adjoins the first cylindrical portion 25.

In the embodiment example shown in FIGS. 2 to 4, the diameter of the conical outer surface 30 at the end of the conical portion 29 facing the first cylindrical portion 25 is smaller than the core diameter d of the threaded spindle 3 (i.e., smaller than the inner diameter of the spindle thread 20), while the diameter of the conical outer surface 30 at the end of the conical portion 29 directed to the longitudinal center is greater than the core diameter d of the threaded spindle 3. As a result, the spindle thread 20 is completely turned in a portion of the conical portion 29 adjoining the first cylindrical portion 25, and the conical outer surface 30 is accordingly continuous. However, in an adjoining portion of the conical portion 29 in direction of the longitudinal center of the threaded spindle 3, the spindle thread 20 is only partially turned. The conical outer surface is formed by the outer surface of the remaining threaded part so that the conical outer surface 30 has interruptions in this case.

The smallest outer diameter of the conical portion 29 at the end of the conical portion 29 facing the adjoining longitudinal end 37 is at least as large as the outer diameter of the first cylindrical portion 25 and is the same size in the present embodiment example.

In the present embodiment example, the receiving groove 27 for the key 28 extends into the conical portion 29. In this case, the bottom of the receiving groove 9 in the first cylindrical portion 25 lies in the same plane as in the conical portion 29. Because of the conical widening, the key 28 which likewise extends in the conical portion 29 in the assembled state of the adjusting device projects radially in the conical portion 29 as the distance 30 increases. In the present embodiment example, the receiving groove 27 and the key end approximately at the location of the conical portion 29 at which the key no longer projects over the conical outer surface 30.

The fastening portion 19 further comprises a second cylindrical portion 31 which lies closer to the longitudinal center of the threaded spindle 3 in relation to the conical portion 29. The second cylindrical portion 31 preferably directly adjoins the conical portion 29.

In the present embodiment example of the invention, the second cylindrical portion 31 has two areas 32, 33 with different outer diameters. The first area 32 which lies on the side of the second cylindrical portion 31 situated closer to the conical portion 29 has a smaller diameter than the second area 33.

The outer diameter of the first area 32 is at least as large as the outer diameter of the conical portion 29 at its largest point (that is, at the end of the conical portion 29 facing the longitudinal center of the threaded spindle 3), but is smaller than the outer diameter D of the threaded spindle 3 in its main portion 18 (i.e., smaller than the outer diameter of the spindle thread 20) which extends over most of the length of the threaded spindle 3.

In the embodiment example according to FIGS. 2 to 4, the spindle thread 20 is partially turned in the first area 32 of the second cylindrical portion 31. The remaining portion of the spindle thread 20 forms a discontinuous cylindrical portion 34.

In the embodiment example according to FIGS. 2 to 4, the spindle thread 3 has been turned very slightly in the second area 33 in order to compensate for manufacturing tolerances of the spindle thread and to form a defined cylindrical outer surface 35 (which has interruptions because it is formed by the outer surface of the remaining thread). This turning is so slight that it is not visible in FIGS. 2 and 3.

The through-opening 6 of the carrier toothed wheel 2 has a first cylindrical portion 38 which serves to receive the first cylindrical portion 25 of the threaded spindle 3, wherein there is only a slight clearance, preferably a sliding fit between the cylindrical portion 38 of the through-opening 6 and the cylindrical portion 25 of the threaded spindle 3, and the clearance of this sliding fit is preferably less than 3/100 mm.

Further, an axial receiving groove is formed in the first cylindrical portion 38 for receiving the key 28.

Further, the through-opening 6 has a conical portion 39 which serves to receive the conical portion 29 of the fastening portion 19 of the threaded spindle 3, wherein the conical portion 29 of the fastening portion 19 contacts the wall of the through-opening 6 in its conical portion 39 in the assembled state of the adjusting device. The receiving groove for the key 28 preferably extends into this conical portion 39, wherein the base of the receiving groove lies in the same plane in the cylindrical portion 38 and in the conical portion 39, and the receiving groove extends up to the location of the conical portion 39 at which the base of the receiving groove reaches the outer surface area of the conical portion 39.

Further, in the present embodiment example, the through-opening 6 has a second cylindrical portion 40 serving to receive the second cylindrical portion 3 over its first area 32. In this case, there is a close sliding fit with only a very slight clearance (preferably less than 2/100 mm).

In the second cylindrical portion 31, the threaded spindle 3 passes through the bushing 13, specifically in the second area 33 of the second cylindrical portion 31. There is a slight clearance between the inner surface of the bushing 13 and the cylindrical outer surface 35 which is preferably less than 8/100 mm, e.g., between 3/100 and 5/100 mm.

In the absence of transverse forces, the threaded spindle 3 should not contact the bushing 13 as far as possible. When acted upon by transverse forces, the threaded spindle 3 is supported at the bushing 13.

The threaded spindle 3 is mounted by inserting it into the carrier toothed wheel 2 with the key 28 inserted until the end portion 22 projects from the through-opening 6. With the cover 14 removed, the clamping nut 24 is screwed onto the screw thread 23 of the end portion 22 and tightened. Due to the contact of the conical outer surface 30 at the driving toothed wheel 7, an axial fastening of the threaded spindle 3 is brought about in the area of the conical portion 39 of the through-opening 6 and its longitudinal axis 41 is oriented relative to the axis of rotation 42 of the carrier toothed wheel 2 so that their two axes 41, 42 are parallel and concentric to one another, i.e., coincide with one another.

Further, FIG. 3 schematically shows a load 43 which is connected to the spindle nut 21 and adjusted by the spindle nut 21 in that the latter is displaced axially along the threaded spindle 3. The spindle nut 21 is fixed with respect to rotation by means of the connection of the spindle nut 21 to the load 43.

FIG. 5 shows the connection of a threaded spindle 3 to the base unit shown in FIG. 1, wherein this threaded spindle 3 has a greater core diameter d and therefore also a greater outer diameter D than the threaded spindle 3 shown in FIG. 3. The spindle thread 20 is completely turned in the fastening portion 19 of the threaded spindle 3 in order to form the portions 22, 25, 29, 31 of the fastening portion 19.

FIG. 6 shows a threaded spindle 3 which is connected to the base unit of FIG. 1 and which has a greater core diameter d and outer diameter D compared to it.

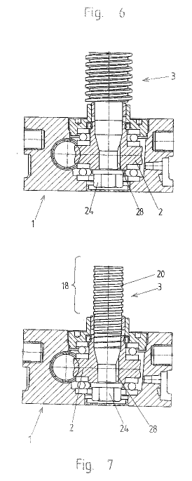

FIG. 7 shows a threaded spindle 3 mounted in the base unit of FIG. 1 with a spindle thread 20 formed as a ball thread. In this case, the core diameter d of this threaded spindle 3 is slightly smaller than the diameter of the cylindrical outer surface 34 in the first area 32 of the second cylindrical portion 31.

Therefore, as is shown, threaded spindles 3 with different core diameters d and outer diameters D can be used in combination with the same gear unit housing 1 with toothed wheels 2, 7 which are rotatable therein by corresponding machining of the threaded spindles 3 in the fastening portion 19. Commercially available standard spindles can be used as starting products for the threaded spindles 3.

The first area 32 and the second area 33 of the second cylindrical portion 31 can also have the same outer diameter.

In principle, it would also be conceivable and possible for the fastening portion 19 to terminate after the conical portion 29 toward the longitudinal center of the threaded spindle 3, so that the second cylindrical portion is dispensed with. The second cylindrical portion 40 of the carrier toothed wheel 2 could then likewise be omitted, and the threaded spindle 3 could exit from the gear unit housing 1 through the bushing 13 in the main portion 18 that is not machined.

However, it is preferable that at least a second cylindrical portion 31 is provided with a first area 32 which cooperates with the second cylindrical portion 40 of the through-opening 6 in order to achieve additional support of the threaded spindle 3 relative to transverse forces and to improve centering of the threaded spindle 3. Further, it is preferable that the threaded spindle 3 is also machined in a second area 33 of the second cylindrical portion 31 relative to the main portion 18 in order to enable a smaller clearance between the bushing 13 and the threaded spindle 3.

As follows from the preceding description, the field of the invention is not limited to the embodiment examples shown herein, but rather should be defined with reference to the appended claims together with their full range of possible equivalents. While the preceding description and drawings show the invention, it is obvious to the person skilled in the art that various modifications can be carried out without departing from the spirit of and field of the invention.

### REFERENCE NUMBERS

1 gear unit housing
2 carrier toothed wheel
3 threaded spindle
4 axial bearing
5 axial bearing
6 through-opening
7 driving toothed wheel
8 housing base part
9 receiving space
10 housing cover
11 opening
12 annular flange
13 bushing
14 cover
15 lubricating bore hole
16 recess
17 swivel bearing bush
18 main portion
19 fastening portion
20 spindle thread
21 spindle nut
22 end portion
23 screw thread
24 clamping nut
25 first cylindrical portion
26 cylindrical outer surface
27 receiving groove
28 key
29 conical portion
30 conical outer surface
31 second cylindrical portion
32 first region
33 second region
34 cylindrical outer surface
35 cylindrical outer surface
36 expansion portion
37 longitudinal end
38 first cylindrical portion
39 conical portion
40 second cylindrical portion
41 longitudinal axis
42 axis of rotation
43 load

What is claimed is:

1. Adjusting device for positioning a load, comprising:
a threaded spindle which is connected in the region of a longitudinal end to a carrier toothed wheel so as to be fixed with respect to rotation relative to it and so as to be fixed with respect to displacement axially;
said carrier toothed wheel being rotatably mounted in a gear unit housing and able to be set in rotation by a driving toothed wheel whose teeth engage in the teeth of the carrier toothed wheel;
a spindle nut which is arranged on a spindle thread of the threaded spindle and which is displaceable axially by a rotation of the threaded spindle for positioning the load;
a fastening portion of the threaded spindle which is formed in the region of the longitudinal end of the threaded spindle and along which the spindle thread is at least partially turned penetrating a central through-opening through the carrier toothed wheel and being connected to the carrier toothed wheel by a key and, further, being provided with a screw thread in an end portion which projects out of the through-opening of the carrier toothed wheel;
a clamping nut which clamps the threaded spindle against the carrier toothed wheel being screwed onto this screw thread;
said fastening portion having, in addition to a cylindrical portion which is received by a cylindrical portion of the through-opening of the carrier toothed wheel and in which torque is transmitted between the carrier toothed wheel and the fastening portion by the key;
another conical portion which is situated closer to the longitudinal center of the threaded spindle and which widens in direction of the longitudinal center of the threaded spindle and which is received by a conical portion of the through-opening of the carrier toothed wheel; and
said conical portion of the fastening portion and the conical portion of the carrier toothed wheel being clamped against one another by the clamping nut.

2. The adjusting device according to claim 1, wherein the cylindrical portion of the fastening portion adjoins the end portion of the fastening portion provided with the screw thread by way of portion.

3. The adjusting device according to claim 1, wherein the cylindrical portion of the fastening portion is received by the cylindrical portion of the through-opening of the carrier toothed wheel by a sliding fit.

4. The adjusting device according to claim 1, wherein the conical portion directly adjoins the cylindrical portion.

5. The adjusting device according to claim 1, wherein a receiving groove for the key, which receiving groove extends in the cylindrical portion, also extends at least along a portion of the conical portion adjoining the cylindrical portion, and the base of the receiving groove lies in the same plane in the cylindrical portion and in the conical portion, and the key which is arranged in the receiving groove and which is received by a receiving groove in the carrier toothed wheel also extends along a portion of the conical portion adjoining the cylindrical portion of the fastening portion and conical portion of the through-opening adjoining the cylindrical portion of the through-opening.

6. The adjusting device according to claim 1, wherein the fastening portion has, in addition to the first cylindrical portion lying between the end portion having the screw thread and the conical portion, a second cylindrical portion which is situated closer to the longitudinal center of the threaded spindle than the conical portion and is received along at least part of its longitudinal extension by a second cylindrical portion of the through-opening of the carrier toothed wheel.

7. The adjusting device according to claim 6, wherein the second cylindrical portion is received by the second cylindrical portion of the through-opening in a sliding fit.

8. The adjusting device according to claim 6, wherein the second cylindrical portion directly adjoins the conical portion.

9. The adjusting device according to claim 6, wherein the second cylindrical portion further penetrates a bushing with play, which bushing is inserted into an opening in the gear unit housing.

10. The adjusting device according to claim 9, wherein this play is less than 8/100 mm.

11. The adjusting device according to claim 6, wherein the second cylindrical portion has a first area with a smaller outer diameter which is received by the second cylindrical portion of the through-opening of the carrier toothed wheel and a second area with a greater outer diameter, which second area penetrates the bushing.

12. The adjusting device according to claim 6, wherein the outer diameter of the second cylindrical portion is at least as large as the largest outer diameter of the conical portion.

13. The adjusting device according to claim 1, wherein the smallest outer diameter of the conical portion is at least as large as the outer diameter of the first cylindrical portion of the fastening portion.

14. The adjusting device according to claim 1, wherein the carrier toothed wheel is constructed as a worm wheel.

15. The adjusting device according to claim 1, wherein the driving toothed wheel is constructed as a worm.
